(19) United States
(12) Patent Application Publication
(10) Pub. No.: US 2010/0238137 A1
(43) Pub. Date: Sep. 23, 2010

(54) Multi-telepointer, virtual object display device, and virtual object control method

(75) Inventors: Seung-ju Han, Seoul (KR); Joon-ah Park, Seoul (KR); Wook Chang, Seoul (KR); Hyun-jeong Lee, Seoul (KR); Chang-yeong Kim, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Gyeonggi-do (KR)

(21) Appl. No.: 12/659,759

(22) Filed: Mar. 19, 2010

(30) Foreign Application Priority Data
Mar. 23, 2009 (KR) 10-2009-0024504
Feb. 8, 2010 (KR) 10-2010-0011639

(51) Int. Cl. G06F 3/01; G06F 3/042

(52) U.S. Cl. 345/175; 715/863

(57) ABSTRACT

A virtual object control method is provided. The virtual object control method includes selecting a gesture to control a virtual object on the basis of motion information of a virtual object control unit. The gesture is related to a user's action to operate the virtual object control unit, and appropriately selected so that a user can intuitively and remotely control the virtual object. Selection criteria may be varied depending on the motion information including at least one of a pointing position, the number of pointed to points, a moving type for the virtual object control unit, and a moving position for the virtual object control unit acquired based on the position information.

### CROSS-REFERENCE TO RELATED APPLICATIONS

This application claims the benefit under 35 U.S.C. §119(a) of Korean Patent Application Nos. 10-2009-0024504, filed on Mar. 23, 2009, and 10-2010-0011639, filed on Feb. 8, 2010, in the Korean Intellectual Property Office, the entire disclosures of which are incorporated herein by reference for all purposes.

### BACKGROUND

1. Field

One or more embodiments relate to pointing input technology and gesture recognition technology for controlling a virtual object.

2. Description of the Related Art

In recent times, as the capabilities of terminals such as personal digital assistants (PDAs), mobile phones, etc., are increasingly having additional functions, additional user interfaces have also been provided in response to these additional functions. For example, recently developed terminals include various menu keys or buttons for the additional user interfaces.

However, since many various kinds of functions are provided and the various menu keys or buttons are typically not intuitively disposed, it may be difficult for users of the terminals to learn how to operate the menu keys for specific functions.

One of the typical intuitive interfaces for the purpose of use-convenience is a touch interface, for example. Here, the touch interface is one of the simplest interface methods for directly interacting with virtual objects displayed on a screen or the touch interface.

### SUMMARY

In one or more embodiments, there is provided a virtual object control method including detecting position information of a virtual object control unit remotely interacting with a virtual object, detecting motion information including at least one of a pointing position, a number of pointed to points, a moving type for moving the virtual object control unit, and a moving position of the virtual object control unit using the detected position information, and selecting a gesture to control the virtual object based on the detected motion information, and linking the selected gesture to the virtual object, and performing an event corresponding to the selected gesture with respect to the virtual object.

In one or more embodiments, there is provided a virtual object display device including a position detector to detect position information of a virtual object control unit to remotely interact with a virtual object, a gesture determination part to detect motion information including at least one of a pointing position, a number of pointed to points, a moving type for moving the virtual object control unit, and a moving position of the virtual object control unit using the detected position information, and to select a gesture for controlling the virtual object based on the detected motion information, and an event executor to link the selected gesture to the virtual object and to execute an event corresponding to the selected gesture with respect to the virtual object.

In one or more embodiments, the selected gesture may be at least one of a selection gesture, an expansion/contraction gesture, and a rotation gesture according to the detection motion information, i.e., a pointing position, a number of pointed to points, a moving type for moving the virtual object control unit, and a moving position of the virtual object control device. The motion information may be detected from the position information of the virtual object control unit, and the position information of the virtual object control unit may be acquired from an optical signal received from the virtual object control unit or a distance measured from the virtual object control unit.

In one or more embodiments, there is provided a multi-telepointer including a light projector to project an optical signal, an input detector to detect touch and moving information, and an input controller to control the light projector and provide detected information including position information and the touch and moving information through the optical signal.

Other features will become apparent to those skilled in the art from the following detailed description, which, taken in conjunction with the attached drawings, discloses one or more embodiments of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a diagram illustrating a virtual object system, according to one or more embodiments;

FIGS. 2A and 2B are diagrams illustrating an appearance of a virtual object control device, according to one or more embodiments;

FIG. 3 is a block diagram illustrating an internal make up of a virtual object control device, according to one or more embodiments;

FIGS. 4A and 4B are diagrams of an external make up of a virtual object display device, according to one or more embodiments;

FIG. 5 is a block diagram illustrating an internal make up of a virtual object display device, according to one or more embodiments;

FIG. 6 is a flowchart illustrating a virtual object control method, according to one or more embodiments;

FIGS. 7A to 7D are flowcharts illustrating another virtual object control method, according to one or more embodiments;

FIG. 8 is a flowchart illustrating still another virtual object control method, according to one or more embodiments;

FIG. 9 is a diagram illustrating a virtual object selection method, according to one or more embodiments;

FIG. 10 is a diagram illustrating a virtual object moving method, according to one or more embodiments;

FIGS. 11A to 11C are diagrams illustrating a virtual object expansion/contraction method, according to one or more embodiments;

FIGS. 12A to 12D are diagrams illustrating a virtual object rotating method, according to one or more embodiments; and

FIG. 13 is a block diagram illustrating an internal make up of a virtual object display device, according to one or more embodiments.

### DETAILED DESCRIPTION

Reference will now be made in detail to embodiments, examples of which are illustrated in the accompanying drawings, wherein like reference numerals refer to like elements throughout. In this regard, embodiments of the present invention may be embodied in many different forms and should not be construed as being limited to embodiments set forth herein. Accordingly, embodiments are merely described below, by referring to the figures, to explain aspects of the present invention.

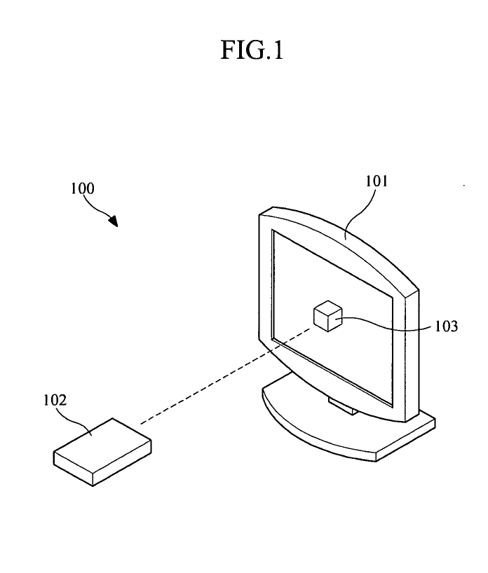

FIG. 1 is a diagram illustrating a virtual object system, according to one or more embodiments.

Referring to FIG. 1, a virtual object system 100 includes a virtual object display device 101 and a virtual object control device 102.

The virtual object display device 101 provides a virtual object 103. For example, the virtual object display device 101 can display the virtual object 103 on a display screen provided therein. Here, the virtual object 103 may be one of various characters, icons, avatars, and virtual worlds, which are expressed in three-dimensional graphic images. The virtual object display device 101 providing such a virtual object 103 may be a television, a computer, a mobile phone, a personal digital assistant (PDA), etc.

The virtual object control device 102 remotely interacts with the virtual object. The virtual object control device 101 may use a portion of a user's body. In addition, the virtual object control device 102 may be a pointing device such as a remote controller for emitting a predetermined optical signal. For example, a user can operate his/her finger or a separate pointing device to select the virtual object 103 displayed on the virtual object display device 101 or move, rotate or expand/contract the selected virtual object 103.

The virtual object display device 101 detects position information of the virtual object control device 102, and acquires motion information of the virtual object control device 102 on the basis of the detected position information.

The position information of the virtual object control device 102 may be three-dimensional position coordinates of the virtual object control device 102. The virtual object display device 101 can acquire three-dimensional position coordinates of the virtual object control device 102 using an optical response sensor for detecting an optical signal emitted from the virtual object control device 102 or a distance sensor for measuring a distance of the virtual object control device 102.

In addition, the motion information of the virtual object control device 102 may be a pointing position, the number of pointed to points, a moving type for moving the virtual object control device 102, a moving position of the virtual object control device 102, etc., calculated on the basis of the detected position information. Here, the pointing position refers to a specific position of the virtual object display device 101 pointed to by the virtual object control device 102. In addition, the number of points may be the number of pointing positions. Further, the moving type of the virtual object control device 102 may be a straight line or a curved line depending on variation in pointing position. The moving position may indicate whether the moving type is generated from a position inside or outside of the virtual object 103.

The virtual object display device 101 selects an appropriate gesture for controlling the virtual object 103 according to the acquired motion information of the virtual object control device 102. That is, the virtual object display device 101 can analyze a user's action to operate the virtual object control device 102, and determine a gesture appropriate to the user's action according to the analyzed results. The determined gesture may be a selection gesture for selecting the virtual object 103, a moving gesture for changing a display position of the virtual object 103, an expansion/contraction gesture for increasing or reducing the size of the virtual object 103, and a rotation gesture for rotating the virtual object 103. How the virtual object display device 101 selects which gesture using the acquired motion information will be described below in more detail.

When a predetermined gesture is selected, the virtual object display device 101 links the selected gesture to the virtual object 103. Then, the virtual object display device 101 performs an event corresponding to the selected gesture. For example, virtual object display device 101 can select, move, expand/contract, or rotate the virtual object 103.

As described above, since the virtual object display device 101 detects motion information of the virtual object control device 102, selects an appropriate gesture according to the detected motion information, and then controls selection, movement, expansion/contraction, and rotation of the virtual object 103 according to the selected gesture, a user can intuitively operate the virtual object control device 102 to control the virtual object as in the real world.

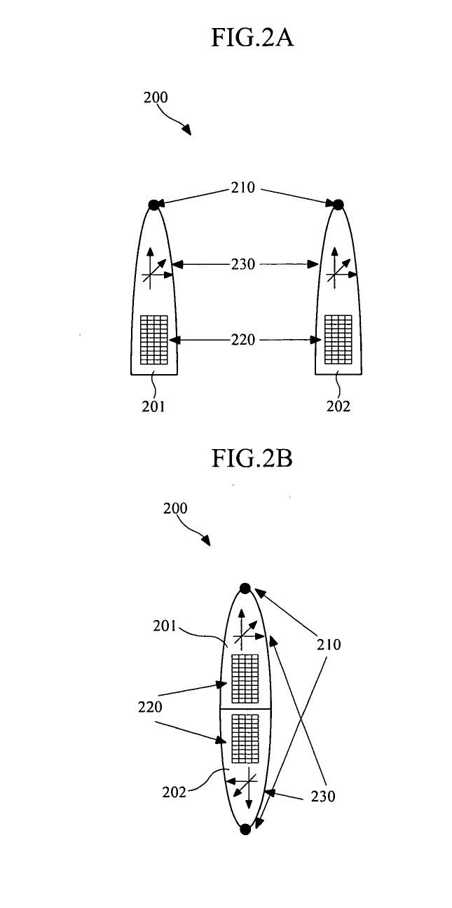

FIGS. 2A and 2B are diagrams illustrating an appearance of a virtual object control device, according to one or more embodiments.

Referring to FIG. 2A, a virtual object control device 200 includes a first virtual object control device 201 and a second virtual object control device 202. In addition, each of the virtual object control devices 201 and 202 includes an emission device 210, a touch sensor 220, and a motion detection sensor 230.

Further, the first virtual object control device 201 may be coupled to the second virtual object control device 202 as shown in FIG. 2B, i.e., at the non-light emission device ends of the virtual object control device 202. For example, in use, as shown in FIG. 2A, a user can use them with the first virtual object control device 210 in one hand and the second virtual object control device 202 in the other hand. In addition, in storage, the first and second virtual object control devices 201 and 202 are coupled to each other and stored as shown in FIG. 2B. However, the present invention is not limited thereto but may be used in the coupled state as shown in FIG. 2B.

In FIGS. 2A and 2B, the emission device 210 emits light. The light emitted from the emission device 210 may be an infrared light or a laser beam. For example, the emission device 210 may be implemented through a light emitting diode (LED) device.

The touch sensor 220 detects whether a user contacts it or not. For example, the touch sensor 220 may be formed using a button, a piezoelectric device, a touch screen, etc. The touch sensor 220 may be modified in various shapes. For example, the touch sensor 220 may have circular, oval, square, rectangular, triangular, or other shapes. An outer periphery of the touch sensor 220 defines an operation boundary of the touch sensor 220. When the touch sensor 220 has a circular shape, the circular touch sensor enables a user to freely and continuously move his/her finger in a vortex shape. In addition, the touch sensor 220 may use a sensor for detecting a pressure, etc., of a finger (or a subject). For example, the sensor may be operated on the basis of resistive detection, surface acoustic wave detection, pressure detection, optical detection, capacitive detection, etc. A plurality of sensors may be activated when a finger is disposed on the sensors, taps the sensors, or passes over the sensors. When the touch sensor 220 is implemented as a touch screen, it is also possible to guide various interfaces for controlling the virtual object 103 and controlled results through the touch sensor 220.

The motion detection sensor 230 measures acceleration, angular velocity, etc., of the virtual object control device 200. For example, the motion detection sensor 230 may be a gravity detection sensor or an inertia sensor.

When a user operates the virtual object control device 200, the virtual object control device 200 can put touch information of a user generated from the touch sensor 220 or operation information of a user generated from the motion detection sensor 230 into an optical signal of the emission device 210 to provide the information to the virtual object display device 101.

The virtual object control device 200 may be a standalone unit or may be integrated with an electronic device. In the case of the standalone unit, the virtual object control device 200 has its own housing, and in the case of the integration type, the virtual object control device 200 may use a housing of the electronic device. Here, the electronic device may be a PDA, a media player such as a music player, a communication terminal such as a mobile phone, etc.

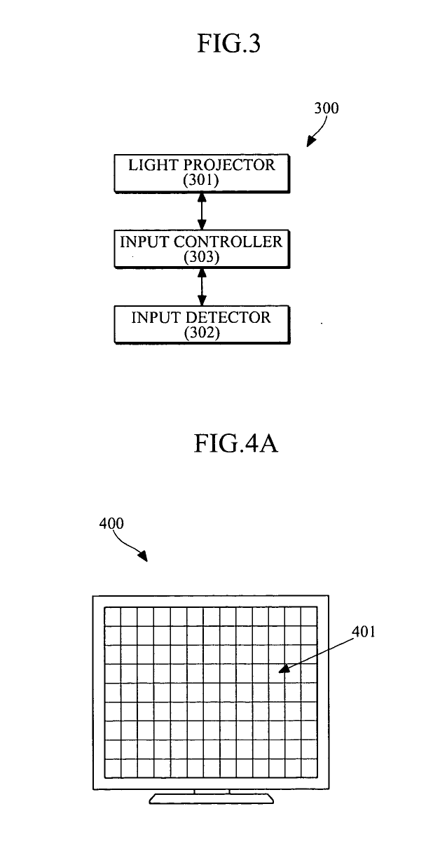

FIG. 3 is a block diagram illustrating an internal make up of a virtual object control device, according to one or more embodiments.

Referring to FIG. 3, a virtual object control device 300 includes a light projector 301, an input detector 302, and an input controller 303.

The light projector 301 corresponds to an emission device 210, and generates a predetermined optical signal.

The input detector 302 receives touch information and motion information from a touch sensor 220 and a motion detection sensor 230, respectively. The input detector 302 can appropriately convert and process the received touch information and motion information. The converted and processed information may be displayed on the touch sensor 220 formed as a touch screen.

The input controller 303 controls the light projector 301 according to the touch information and motion information of the input detector 302. For example, a wavelength of an optical signal can be adjusted depending on whether a user pushes the touch sensor 220 or not. In addition, optical signals having different wavelengths can be generated depending on the motion information.

For example, a user can direct the light projector 301 toward a desired position, and push the touch sensor 220 so that light can enter a specific portion of the virtual object display device 101 to provide a pointing position.

While FIGS. 2A, 2B and 3 illustrate the virtual object control devices 200 and 300 generating predetermined optical signals, the virtual object control devices 200 and 300 are not limited thereto. For example, a user may use his/her hands, not using a separate tool.

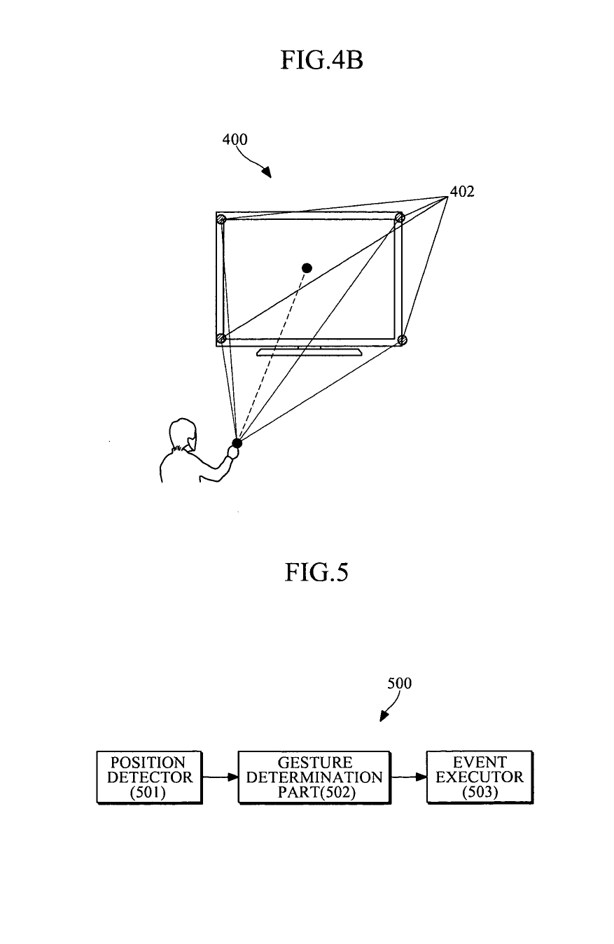

FIGS. 4A and 4B are diagrams of an external make up of a virtual object display device, according to one or more embodiments.

Referring to FIG. 4A, a virtual object display device 400 includes a plurality of optical response devices 401. For example, the virtual object display device 400 may include an in-cell type display in which the optical response devices 401 are arrayed between cells. Here, the optical response device 401 may be a photo diode, a photo transistor, cadmium sulfide (CdS), a solar cell, etc.

When the virtual object control device 102 emits an optical signal, the virtual object display device 400 can detect an optical signal of the virtual object control device 102 using the optical response device 401, and acquire three-dimensional position information of the virtual object control device 102 on the basis of the detected optical signal.

Referring to FIG. 4B, the virtual object display device 400 includes a motion detection sensor 402. The motion detection sensor 402 can recognize a user's motion to acquire three-dimensional position information like an external referenced positioning display.

When the virtual object control device 102 emits an optical signal, the motion detection sensor 402 can detect an optical signal and acquire three-dimensional position information of the virtual object control device 102 on the basis of the detected optical signal. In addition, when a user's hand is used as the virtual object control device 102, it is possible for at least two motion detection sensors 402 to measure a distance to a user's hand and apply trigonometry to the measured distance, acquiring three-dimensional position information of the user's hand.

In FIGS. 4A and 4B, users can share a plurality of virtual objects in one screen through the virtual object display device 400. For example, when a user interface technique is applied to a flat display such as a table, it is possible for many people to exchange information and make decisions between the users and the system at a meeting, etc.

FIG. 5 is a block diagram illustrating an internal make up of a virtual object display device, according to one or more embodiments.

Referring to FIG. 5, a virtual object display device 500 includes a position detector 501, a gesture determination part 502, and an event executor 503.

The position detector 501 detects position information of the virtual object control device 102 remotely interacting with the virtual object 103. For example, the position detector 501 can detect an optical signal emitted from the virtual object control device 102 through the optical response device 401 to acquire three-dimensional position information on the basis of the detected optical signal. In addition, while the virtual object control device 102 does not emit an optical signal, the position detector 501 can measure a distance to the virtual object control device 102 through the motion detection sensor 402 to acquire three-dimensional position information on the basis of the measured distance.

The gesture determination part 502 detects motion information of the virtual object control device 102 using the detected position information, and selects a gesture for controlling the virtual object 103 on the basis of the detected motion information. The motion information may include at least one of a pointing position, the number of points, a moving type, and a moving position of the virtual object control device 102. The selected gesture may be at least one of a selection gesture for selecting the virtual object 103, a moving gesture for changing a display position of the virtual object 103, an expansion/contraction gesture for increasing or reducing the size of the virtual object 103, and a rotation gesture for rotating the virtual object 103. For example, the gesture determination part 502 can determine whether an operation of the virtual object control device 102 by the user is to select, move, rotate, or expand/contract the virtual object 103 on the basis of the detected motion information.

The event executor 503 links the selected gesture to the virtual object 103, and executes an event corresponding to the selected gesture of the virtual object 103. For example, the event executor 503 can select, move, rotate, or expand/contract the virtual object 103 depending on the selected gesture.

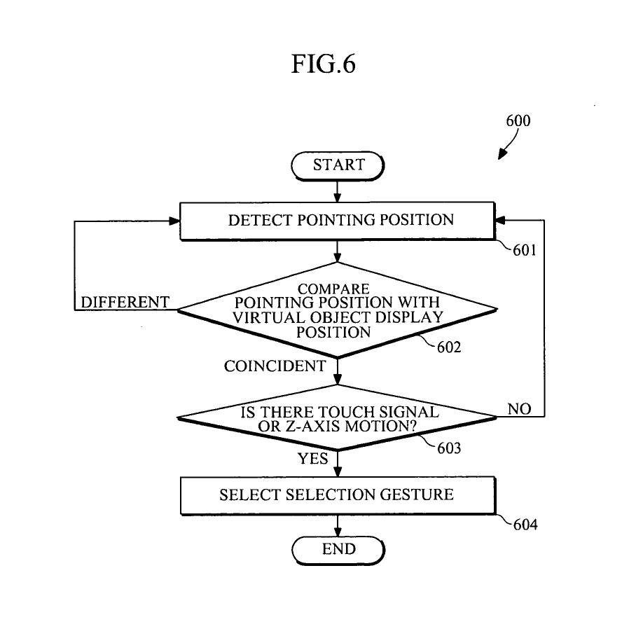

FIG. 6 is a flowchart illustrating a virtual object control method, which may be an example of a method of determining the selected gesture, according to one or more embodiments.

Referring to FIG. 6, a virtual object control method 600 includes, first, detecting a pointing position of a virtual object control device 102 (operation 601). The pointing position of the virtual object control device 102 may be acquired on the basis of position information detected by an optical response sensor 401 or a motion detection sensor 402.

The virtual object control method 600 includes determining whether the detected pointing position substantially coincides with a display position of the virtual object 103 (operation 602). According to the embodiment, substantial consistency between a pointing position and a display position of the virtual object 103 may include the case that pointing positions about the virtual object 103 form a predetermined closed loop. For example, even when a user points to the virtual object control device 102 around the virtual object 103 to be selected and draws a circle about the virtual object 103, it may be considered that the pointing position substantially coincides with the display position of the virtual object 103.

When the virtual object control method 600 includes determining whether there is a touch signal or a z-axis motion at a position where the detected pointing position substantially coincides with the display position of the virtual object 103 (operation 603), the touch signal may be a specific optical signal or variation in optical signal of the virtual object control device 102 and z-axis motion may be motion in a vertical direction, i.e., a depth direction in a screen of the virtual object display device 101. The touch signal may be generated when a user touches the touch sensor 220 of the virtual object control device 200. The z-axis motion may be acquired on the basis of the position information detected through the optical response sensor 401 or the motion detection sensor 402.

The virtual object control method 600 includes selecting a gesture for selecting the virtual object 103 when there is a touch signal or z-axis motion (operation 604).

When the gesture is selected, the event executor 503 changes a color of the selected virtual object 103 or executes an event of emphasizing a periphery thereof to inform a user of selection of the virtual object 103.

Therefore, the user can coincide the pointing position of the virtual object control device 102 with the virtual object 103 and push a selection button (for example, a touch sensor 220) or move the virtual object control device 102 on a screen of the virtual object display device 101 in a vertical direction, intuitively selecting the virtual object 103.

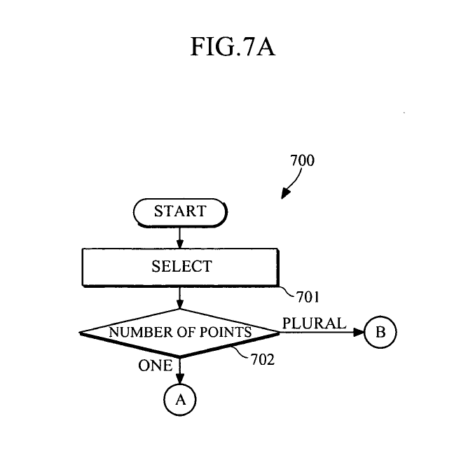

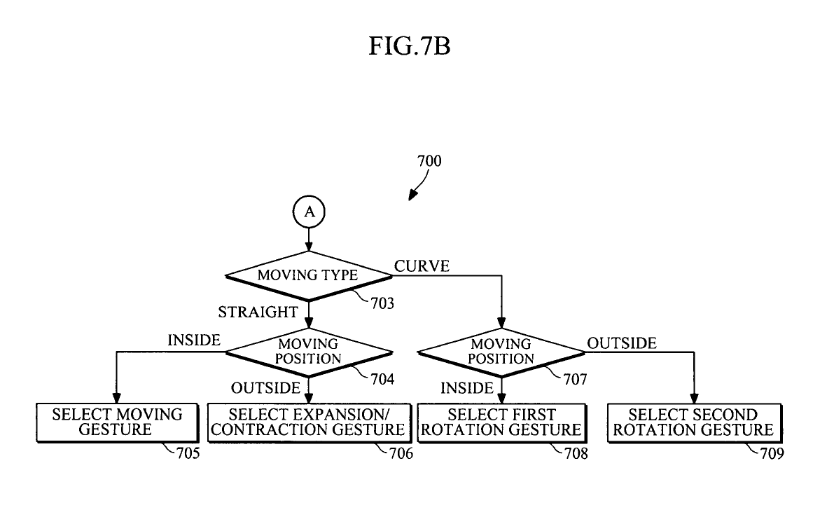

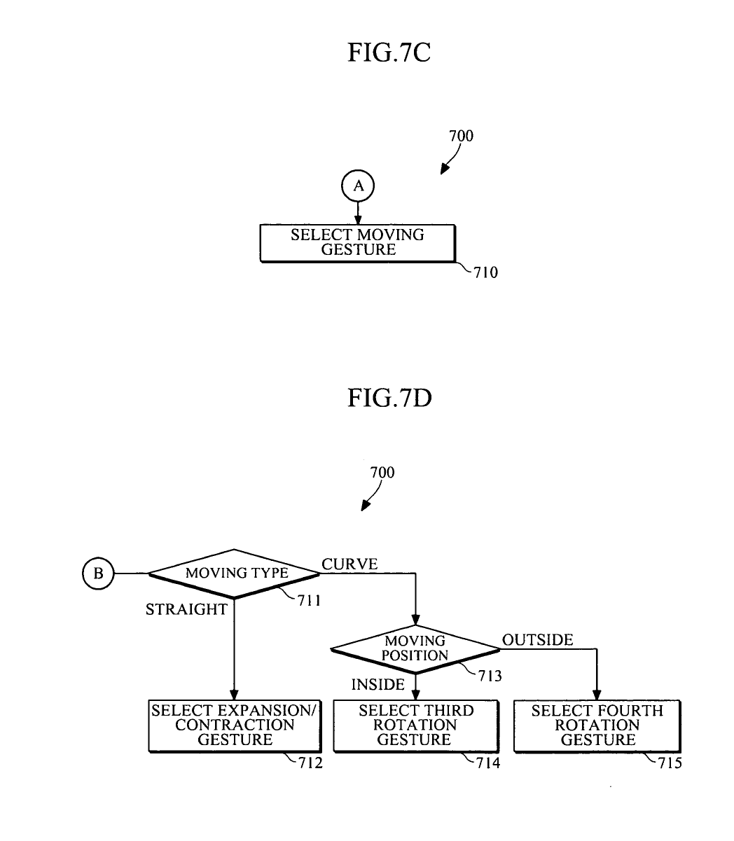

FIGS. 7A to 7D are flowcharts illustrating another virtual object control method, which may be an example of a method of determining a movement, expansion/contraction, or rotation gesture, according to one or more embodiments.

Referring to FIG. 7A, a virtual object control method 700 includes, when a virtual object 103 is selected (operation 701), determining whether the number of points is one or more (operation 702). Whether the virtual object 103 is selected may be determined through the method described in FIG. 6.

When the number of points is one, process A is carried out.

Referring to FIG. 7B as an example of process A, the virtual object control method includes determining whether a moving type is a straight line or a curved line (operation 703). The curved line may be a variation type of pointing positions. When the moving type is the straight line, the virtual object control method 700 includes determining whether a moving position is at the inside or the outside of the virtual object 103 (operation 704). When the moving position is at the inside of the virtual object 103, the virtual object control method 700 includes selecting a gesture for moving the virtual object 103 (operation 705), and when the moving position is at the outside of the virtual object 103, includes selecting a gesture for expanding/contracting the virtual object 103 (operation 706). In addition, when the moving type is the curved line, the virtual object control method 700 includes determining whether the moving position is at the inside or the outside of the virtual object 103 (operation 707). When the moving position is at the inside of the virtual object 103, the virtual object control method 700 includes selecting a first rotation gesture for rotating the virtual object 103 (operation 708), and when the moving position is at the outside of the virtual object 103, includes selecting a second rotation gesture for rotating an environment of the virtual object 103 (operation 709).

Referring to FIG. 7C as another example of process A, the virtual object control method 700 may include, when the number of points is one, instantly selecting a gesture for moving the virtual object 103, not determining the moving type and the moving position (operation 710).

Returning to FIG. 7A, when the number of points is plural, process B is carried out.

Referring to FIG. 7D as an example of process B, the virtual object control method 700 includes determining whether the moving type is a straight line or a curved line (operation 711). When the moving type is the straight line, the virtual object control method 700 includes selecting a gesture for expanding/contracting the virtual object 103 (operation 712). When the moving type is the curved line, the virtual object control method 700 includes determining whether the moving position is at the inside or the outside of the virtual object 103 (operation 713). When the moving position is at the inside of the virtual object 103, the virtual object control method 700 includes setting any one pointing position as a rotation center and selecting a third rotation gesture for rotating the virtual object 103 according to movement of another pointing position (operation 714). When the moving position is at the outside of the virtual object 103, the virtual object control method 700 includes setting any one pointing position as a rotation center and selecting a fourth rotation gesture for rotating an environment of the virtual object 103 according to movement of another pointing position (operation 715).

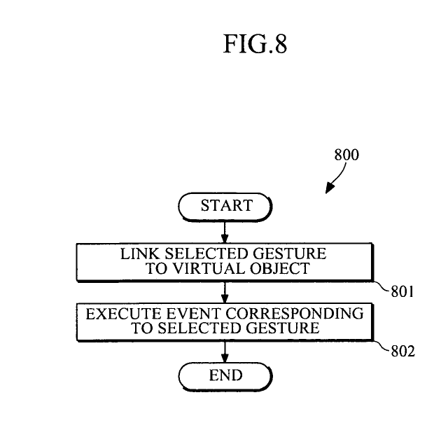

FIG. 8 is a flowchart illustrating still another virtual object control method, which may be an example of a method of executing an event, according to one or more embodiments.

Referring to FIG. 8, when a specific gesture is selected, a virtual object control method 800 includes linking the selected gesture to the virtual object 103 (operation 801).

In addition, the virtual object control method 800 includes performing an event corresponding to the selected gesture corresponding to the virtual object 103 (operation 802). For example, when the gesture is selected, an event of changing a color or a periphery of the virtual object 103 can be performed. When the moving gesture is selected, an event of changing a display position of the virtual object 103 can be performed. When the rotation gesture is selected, an event of rotating the virtual object 103 or an environment of the virtual object 103 can be performed. When the expansion/contraction gesture is selected, an event of increasing or reducing the size of the virtual object 103 can be performed.

As described above, the virtual object display device extracts motion information such as a pointing position, the number of points, a moving type, and a moving position on the basis of position information of the virtual object control device 102, and selects an appropriate gesture according to the extracted motion information, allowing a user to control the virtual object 103 as in the real world.

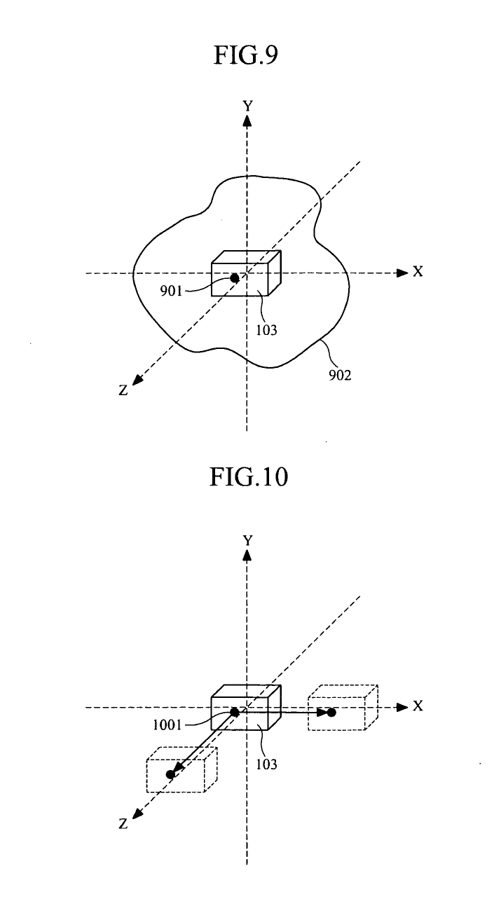

FIG. 9 is a diagram illustrating a virtual object selection method, according to one or more embodiments.

Referring to FIG. 9, a user can touch a touch sensor 220 of a virtual object control device 102 in a state in which the virtual object control device points to the virtual object 103 or move the virtual object control device 102 in a −z-axis direction to select the virtual object 103.

For example, a user may coincide a pointing position 901 with a display position of the virtual object 103 and push the touch sensor 220 or change the pointing position 901 of the virtual object control device 102 in a state in which the user is pushing the touch sensor 220 to draw a predetermined closed loop 902 about the virtual object 103.

Meanwhile, according to the embodiment, when the virtual object 103 is selected, a predetermined guide line may be displayed to perform movement, expansion/contraction, and rotation, which will be described.

FIG. 10 is a diagram illustrating a virtual object moving method, according to one or more embodiments.

Referring to FIG. 10, a user can select the virtual object 103 as shown in FIG. 9, position a pointing position 1001 of a virtual object control device 102 at the inside of the virtual object 103, and operate the virtual object control device 102 such that the pointing position 1001 straightly varies, thereby moving the virtual object 103.

Variation in pointing position, i.e., motion of the virtual object control device 102, can be three-dimensionally performed. For example, when the user selects the virtual object 103 and moves the virtual object control device 102 to the right of the virtual object display device 101 (i.e., a +x-axis direction), the virtual object 103 can move rightward on a screen of the virtual object display device 101. In addition, when the user pulls the virtual object control device 102 in a direction away from the virtual object display device 101 (i.e., a +z-axis direction), the virtual object 103 can move forward from a screen of the virtual object display device 101. Since the screen of the virtual object display device 101 is a two-dimensional plane, forward and rearward movement of the virtual object 103 can be implemented with an appropriate size and variation in position according to the embodiment.

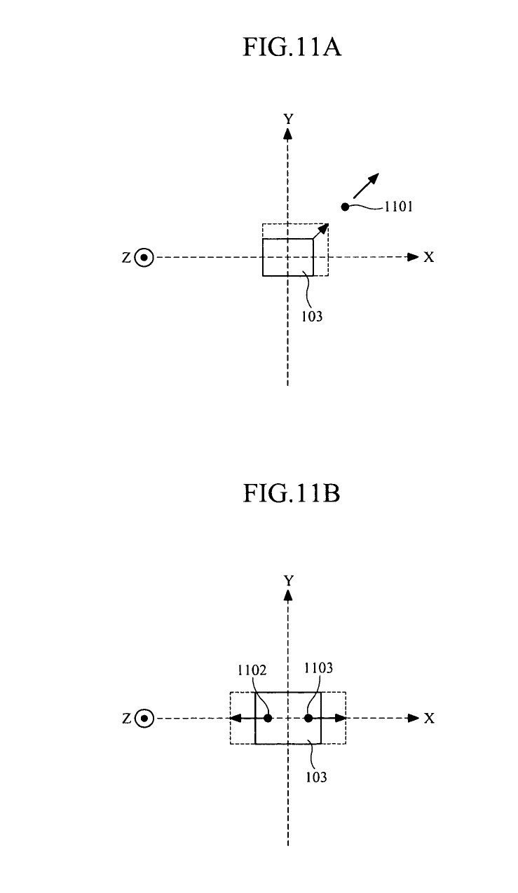

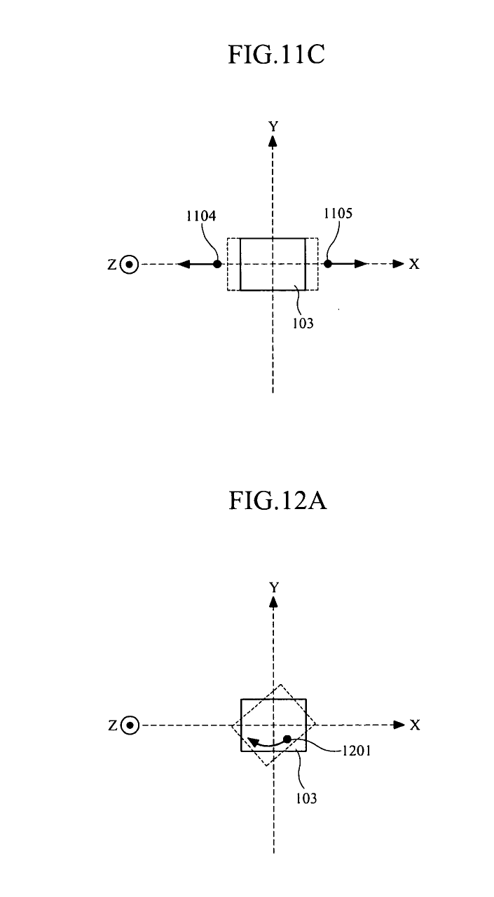

FIGS. 11A to 11C are diagrams illustrating a virtual object expansion/contraction method, according to one or more embodiments.

Referring to FIG. 11A, a user can select the virtual object 103 as shown in FIG. 9, position one pointing position 1101 of a virtual object control device 102 at the outside of the virtual object 103, and operate the virtual object control device 102 such that the pointing position 1101 straightly varies, thereby expanding/contracting the virtual object 103. For example, the user operates the virtual object control device 102 to indicate a boundary or a corner of the virtual object 103, and moves the virtual object control device 102 in +x- and +y-axis directions in a state in which the user is pushing the touch sensor 220 to increase the size of the virtual object 103.

Referring to FIG. 11B, the user can select the virtual object 103 as shown in FIG. 9, position two pointing positions 1102 and 1103 of the virtual object control device 102 at the inside of the virtual object 103, and operate the virtual object control device 102 such that the pointing positions 1102 and 1103 straightly vary, thereby expanding/contracting the virtual object 103. For example, the user can move the virtual object control device 102 to expand the virtual object 103 in −x and +x-axis directions.

Referring to FIG. 11C, the user can select the virtual object 103 as shown in FIG. 9, position two pointing positions 1104 and 1105 of the virtual object control device 102 at the outside of the virtual object 103, and operate the virtual object control device 102 such that the pointing positions 1104 and 1105 straightly vary, thereby expanding/contracting the virtual object 103.

While FIGS. 11A to 11C illustrate the virtual object 103 expanded/contracted in a two-dimensional manner, the virtual object 103 is not limited thereto. It has been illustrated for the convenience of description only, but the virtual object 103 can be three-dimensionally expanded or contracted. For example, in FIG. 11B, any one virtual object control device 210 (see FIG. 2A) corresponding to the first pointing position 1102 can be pulled forward (+z-axis direction) and another virtual object control device 202 (see FIG. 2A) corresponding to the second pointing position 1103 can be pushed rearward (−z-axis direction) to increase the size of the virtual object 103 in −z and +z-axis directions.

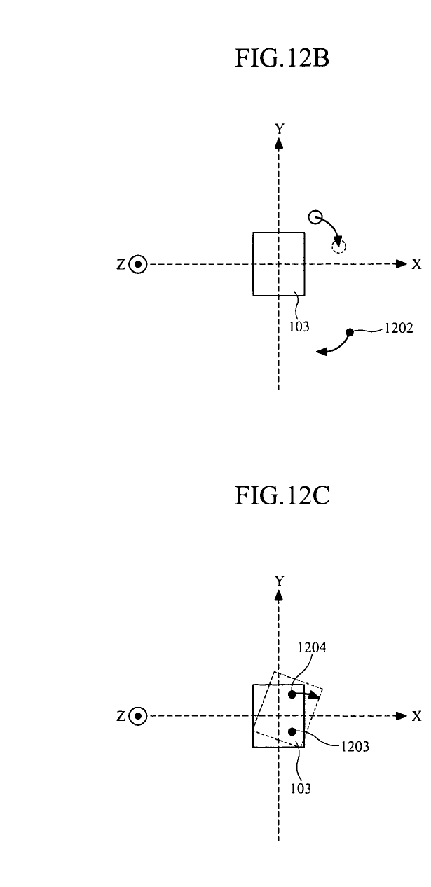

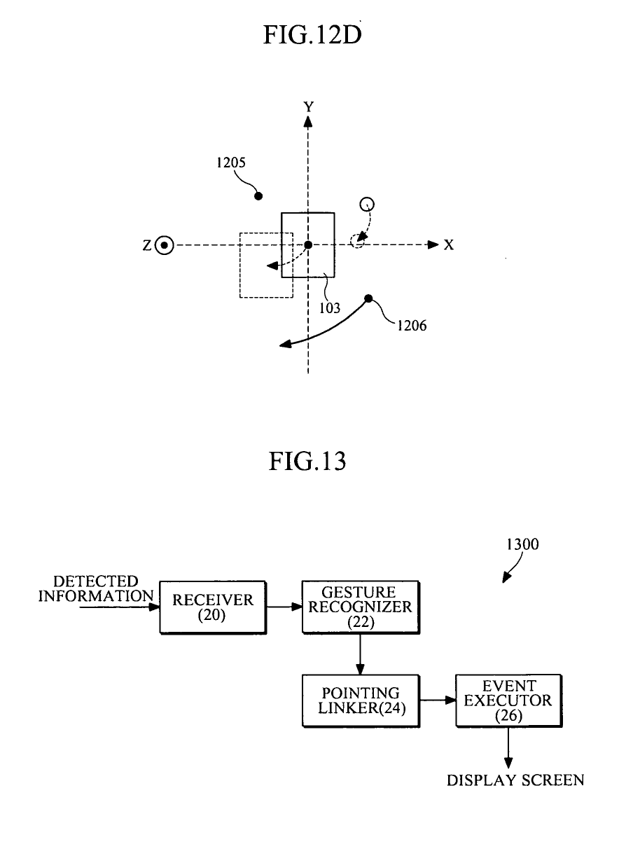

FIGS. 12A to 12D are diagrams illustrating a virtual object rotating method, according to one or more embodiments.

Referring to FIG. 12A, a user can select the virtual object 103 as shown in FIG. 9, position a pointing position 1201 of the virtual object control device 102 at the inside of the virtual object 103, and operate the virtual object control device 102 such that the pointing position 1201 curvedly varies, thereby rotating the virtual object 103. Here, a rotational center may be a center of the virtual object 103 or a center of the curved movement of the pointing position 1201.

Referring to FIG. 12B, a user can select the virtual object 103 as shown in FIG. 9, position a pointing position 1202 of the virtual object control device 102 at the outside of the virtual object 103, and operate the virtual object control device 102 such that the pointing position 1202 curvedly varies, thereby rotating an environment of the virtual object 103. Here, a rotational center may be a center of the virtual object 103 or a center of the curved movement of the pointing position 1202. In addition, optionally, only the environment may be rotated in a state in which the virtual object 103 is fixed, or all the environments may be rotated with the virtual object 103.

Referring to FIG. 12C, a user can select the virtual object 103 as shown in FIG. 9, position first and second pointing positions 1203 and 1204 of the virtual object control device 102 at the inside of the virtual object 103, and operate the virtual object control device 102 such that the second pointing position 1204 curvedly varies, thereby rotating the virtual object 103. Here, a rotational center may be the first pointing position 1203.

Referring to FIG. 12D, a user can select the virtual object 103 as shown in FIG. 9, position first and second pointing positions 1205 and 1206 of the virtual object control device 102 at the outside of the virtual object 103, and operate the virtual object control device 102 such that the second pointing position 1206 curvedly varies, thereby rotating the virtual object 103 and/or an environment of the virtual object 103. Here, a rotational center may be the first pointing position 1205.

While FIGS. 12A to 12D illustrate two-dimensional rotation of the virtual object 103 and/or the environment of the virtual object 103, it is not limited thereto. It has been illustrated for the convenience of description only, but the virtual object 103 can be three-dimensionally rotated. For example, in FIG. 12A, a user pulls the virtual object control device 102 rearward by drawing a circle like pulling a fishing pole in a state in which the pointing position 1201 of the virtual object control device 102 is disposed on the virtual object 103, enabling the virtual object 103 to be rotated about an X axis.

According to an embodiment, the above-mentioned selection, movement, expansion/contraction, and rotation may be individually performed with respect to each virtual object 103, or may be simultaneously performed with respect to any one virtual object 103. For example, it may be possible to move and rotate the virtual object 103, or control movement on an x-y plane to any one pointing position and control movement on a z-axis to another pointing position.

FIG. 13 is a block diagram illustrating an internal make up of a virtual object display device, according to one or more embodiments.

Referring to FIG. 13, a virtual object display device 1300 includes a receiver 20, a gesture recognizer 22, a pointing linker 24, and an event executor 26. The receiver 20 receives an input signal including detected information from the virtual object control device 102. For example, the receiver 20 receives detected information detected through the touch sensor 220 or the motion detection sensor 230. The gesture recognizer 22 analyzes the detected information received through the receiver 20 and extracts position information pointed to by the virtual object control device 102 and touch and motion information of the virtual object control device 102. Then, the gesture recognizer 22 recognizes a gesture depending on the extracted information. Here, the pointed position information includes the number of points, and the motion information includes a moving type and a moving position.

According to the embodiment, the gesture recognizer 22 may recognize designation of a specific point or region to be pointed to by the virtual object control device 102 as a selection operation of the virtual object 103. In addition, the gesture recognizer 22 may recognize a user's gesture as a movement, rotation, or expansion/contraction operation according to the number of points, a moving object and a moving position with respect to the virtual object 103.

The pointing linker 24 links the pointing position pointed to by the virtual object control device 102 to the virtual object 103 displayed on the screen according to the gesture recognized through the gesture recognizer 22.

Meanwhile, the event executor 26 performs an event with respect to the virtual object linked through the pointing linker 24. That is, an event with respect to the virtual object of the gesture recognizer corresponding to the pointing position of the virtual object control device 102 is performed according to the gesture recognized through the gesture recognizer 22. For example, it is possible to perform a selection, movement, rotation, or expansion/contraction operation with respect to the subject. Therefore, even at a remote distance, it is possible to provide a user with a feeling of directly operating the subject in a touch manner.

Embodiments of the present invention may be implemented through a computer readable medium that includes computer-readable codes to control at least one processing device, such as a processor or computer, to implement such embodiments. The computer-readable medium includes all kinds of recording devices in which computer-readable data are stored.

The computer-readable recording medium includes a read only memory (ROM), a random access memory (RAM), a compact disk read only memory (CD-ROM), a magnetic tape, a floppy disk, an optical data storage device, etc. In addition, the computer-readable recording medium may be a distributed networked computer system so that computer-readable codes can be stored and executed in a distributed manner.

While aspects of the present invention has been particularly shown and described with reference to differing embodiments thereof, it should be understood that these embodiments should be considered in a descriptive sense only and not for purposes of limitation. Descriptions of features or aspects within each embodiment should typically be considered as available for other similar features or aspects in the remaining embodiments.

Thus, although a few embodiments have been shown and described, with additional embodiments being equally available, it would be appreciated by those skilled in the art that changes may be made in these embodiments without departing from the principles and spirit of the invention, the scope of which is defined in the claims and their equivalents.

What is claimed is:

1. A virtual object display device comprising:
a position detector to detect position information of a virtual object control unit to remotely interact with a virtual object; and
a gesture determination part to detect motion information including at least one of a pointing position of the virtual object control unit, a number of pointed points of the virtual object control unit, a moving type of the virtual object control unit, and a moving position of the virtual object control unit using the detected position information, and to select a gesture for controlling the virtual object based on the detected motion information.

2. The virtual object display device according to claim 1, further comprising an event executor to link the selected gesture to the virtual object and to execute an event corresponding to the selected gesture with respect to the virtual object.

3. The virtual object display device according to claim 1, wherein the virtual object control unit is at least one of a pointing device, to emit a predetermined optical signal, or a portion of a user's body.

4. The virtual object display device according to claim 1, wherein the gesture for controlling the virtual object is at least one of a selection gesture to select the virtual object, a moving gesture to change a display position of the virtual object, an expansion/contraction gesture to change a size of the virtual object, and a rotation gesture to rotate the virtual object.

5. The virtual object display device according to claim 1, wherein the gesture determination part selects a gesture to select the virtual object when the pointing position substantially coincides with a display position of the virtual object.

6. The virtual object display device according to claim 1, wherein the gesture determination part selects a gesture to move the virtual object when the number of pointed to points is one, the moving type is a straight line, and the moving position is a position inside of the virtual object.

7. The virtual object display device according to claim 1, wherein the gesture determination part selects a gesture to expand/contract the virtual object when the number of pointed to points is one, the moving type is a straight line, and the moving position is a position outside of the virtual object.

8. The virtual object display device according to claim 1, wherein the gesture determination part selects a gesture to rotate the virtual object when the number of pointed to points is one, the moving type is a curved line, and the moving position is a position inside of the virtual object.

9. The virtual object display device according to claim 1, wherein the gesture determination part selects a gesture to rotate an environment of the virtual object when the number of pointed to points is one, the moving type is a curved line, and the moving position is a position outside of the virtual object.

10. The virtual object display device according to claim 1, wherein the gesture determination part selects a gesture to move the virtual object when the number of pointed to points is one.

11. The virtual object display device according to claim 1, wherein the gesture determination part selects a gesture to expand/contract the virtual object when the number of pointed to points is plural, and the moving type is a straight line.

12. The virtual object display device according to claim 1, wherein the gesture determination part selects a gesture to rotate the virtual object about any one pointing position when the number of pointed to points is plural, the moving type is a curved line, and the moving position is a position inside of the virtual object.

13. The virtual object display device according to claim 1, wherein the gesture determination part selects a gesture to rotate an environment of the virtual object about any one pointing position when the number of pointed to points is plural, the moving type is a curved line, and the moving position is a position outside of the virtual object.

14. A virtual object display device comprising:
a gesture recognizer to analyze detected information received from a virtual object control unit, extract position information pointed to by the virtual object control unit and touch and motion information of the virtual object control unit, and recognize a gesture of the virtual object control unit according to the extracted position information, touch information, and motion information;
a pointing linker to link a pointing position pointed to by the virtual object control unit to a subject displayed on a screen according to the recognized gesture; and
an event executor to perform an event with respect to the linked subject.

15. The virtual object display device according to claim 14, wherein the gesture recognizer recognizes the gesture as a movement, rotation, or expansion/contraction operation according to a number of pointed to points, a moving type for moving the virtual object control unit, and a moving position of the virtual object control unit with respect to the subject.

16. A multi-telepointer comprising:
a light projector to project an optical signal;
an input detector to detect touch and moving information of the multi-telepointer; and
an input controller to control the light projector and output detected information including position information of the multi-telepointer and the touch and moving information through the optical signal.

17. The multi-telepointer according to claim 16, wherein the multi-telepointer is divided into at least two parts, each part having a light projection end and a non-light projection end, such that when combined the at least two parts are connected at the non-projection ends.

18. A virtual object control method comprising:
detecting position information of a virtual object control unit remotely interacting with a virtual object; and
detecting motion information including at least one of a pointing position of the virtual object control unit, a number of pointed to points of the virtual object control unit, a moving type of the virtual object control unit, and a moving position of the virtual object control unit using the detected position information, and selecting a gesture to control the virtual object based on the detected motion information.

19. The virtual object control method according to claim 18, further comprising linking the selected gesture to the virtual object, and performing an event corresponding to the selected gesture with respect to the virtual object.

20. The virtual object control method according to claim 18, wherein the detecting of the position information comprises calculating three-dimensional position coordinates of the virtual object control unit using an optical signal output from the virtual object control unit or a measured distance from a virtual object display device to the virtual object control unit.

21. The virtual object control method according to claim 18, wherein the gesture to control the virtual object is at least one of a selection gesture to select the virtual object, a moving gesture to change a display position of the virtual object, an expansion/contraction gesture to change a size of the virtual object, and a rotation gesture to rotate the virtual object.

22. The virtual object control method according to claim 18, wherein the selecting of the gesture comprises selecting a gesture to select the virtual object when the pointing position substantially coincides with a display position of the virtual object.

23. The virtual object control method according to claim 18, wherein the selecting of the gesture comprises selecting a gesture to move the virtual object when the number of pointed to points is one, the moving type is a straight line, and the moving position is a position inside of the virtual object.

24. The virtual object control method according to claim 18, wherein the selecting of the gesture comprises selecting a gesture to expand/contract the virtual object when the number of pointed to points is one, the moving type is a straight line, and the moving position is a position outside of the virtual object.

25. The virtual object control method according to claim 18, wherein the selecting of the gesture comprises selecting a gesture to rotate the virtual object when the number of pointed to points is one, the moving type is a curved line, and the moving position is a position inside of the virtual object.

26. The virtual object control method according to claim 18, wherein the selecting of the gesture comprises selecting a gesture to rotate an environment of the virtual object when the number of pointed to points is one, the moving type is a curved line, and the moving position is a position outside of the virtual object.

27. The virtual object control method according to claim 18, wherein the selecting of the gesture comprises selecting a gesture to move the virtual object when the number of pointed to points is one.

28. The virtual object control method according to claim 18, wherein the selecting of the gesture comprises selecting a gesture to expand/contract the virtual object when the number of pointed to points is plural and the moving type is a straight line.

29. The virtual object control method according to claim 18, wherein the selecting of the gesture comprises selecting a gesture to rotate the virtual object about any one pointing position when the number of pointed to points is plural, the moving type is a curved line, and the moving position is a position inside of the virtual object.

30. The virtual object control method according to claim 18, wherein the selecting of the gesture comprises selecting a gesture to rotate an environment of the virtual object about any one pointing position when the number of pointed to points is plural, the moving type is a curved line, and the moving position is a position outside of the virtual object.
